(19) United States
(12) Patent Application Publication
(10) Pub. No.: US 2015/0037633 A1
(43) Pub. Date: Feb. 5, 2015

(54) BATTERY PACK

(71) Applicant: KABUSHIKI KAISHA TOYOTA JIDOSHOKKI, Aichi-ken (JP)

(72) Inventors: Hirokuni Akiyama, Kariya-shi (JP); Hiromi Ueda, Kariya-shi (JP); Shintaro Watanabe, Kariya-shi (JP); Shimpei Mune, Kariya-shi (JP); Hidefumi Oishi, Kariya-shi (JP); Yoshihiro Katagiri, Kariya-shi (JP)

(21) Appl. No.: 14/384,244

(22) PCT Filed: Mar. 11, 2013
(86) PCT No.: PCT/JP2013/056615

§ 371 Date: Sep. 10, 2014

(30) Foreign Application Priority Data
Mar. 12, 2012 (JP) 2012-054806

(51) Int. Cl. H01M 10/656; H01M 10/617; H01M 10/63

(52) U.S. Cl. CPC H01M 10/5061; H01M 10/502; H01M 10/5008
USPC 429/83

(57) ABSTRACT

A battery pack includes a case and a battery module including secondary cells. Each secondary cell includes a primary surface and a secondary surface. The primary surface includes a terminal, and an inter-cell flow passage is formed between adjacent ones of the secondary cells. A primary flow passage is defined between the primary surfaces and a wall surface of the case that faces the primary surfaces. A secondary flow passage is defined between the secondary surfaces and the wall surface of the case that faces the secondary surfaces. One of the primary flow passage and the secondary flow passage functions as a supply passage that supplies a heat medium to the inter-cell flow passage. The other one of the primary flow passage and the secondary flow passage functions as a discharge passage to which the heat medium is discharged from the inter-cell flow passage.

### TECHNICAL FIELD

The present invention relates to a battery pack that adjusts the temperature of secondary cells by circulating a heat medium through inter-cell flow passages formed between adjacent secondary cells.

### BACKGROUND ART

A secondary cell has a longer life when kept at predetermined specified temperature. Thus, patent document 1 describes a battery pack in which the temperature of secondary cells is adjusted.

As shown in FIG. 10, a battery pack 100 includes a battery assembly 102 accommodated in a case 104. The battery assembly 102 is formed by arranging a plurality of rectangular cells 101 in the thickness direction of the rectangular cells 101 at equal intervals. Heat medium passages 103, through which a heat medium flows, are formed between adjacent ones of the rectangular cells 101. A supply passage 105 is formed in the case 104 above the rectangular cells 101 in the height direction of the rectangular cells 101. The supply passage 105 supplies the heat medium to the heat medium passages 103. In addition, a discharge passage 106 is formed in the case 104 below the rectangular cells 101 in the height direction of the rectangular cells 101. The heat medium discharged from the heat medium passages 103 flows through the discharge passage 106. Further, a fan 107 is arranged in the case 104 to send the heat medium discharged from the discharge passage 106 to the supply passage 105. An intake duct 108 connects an intake port of the fan 107 and the discharge passage 106. A supply duct 109 connects the discharge port of the fan 107 and the supply passage 105. Although not shown in the drawing, a heating and cooling means is arranged between the discharge port of the fan 107 and the supply duct 109.

In the battery pack 100 formed as described above, rotation of the fan 107 sends the heat medium that is heated or cooled by the heating and cooling means to the supply passage 105 through the supply duct 109. The heat medium is then supplied to the heat medium passages 103 from the supply passage 105. The heat medium supplied to the heat medium passages 103 heats or cools the rectangular cells 101. The heat medium flowing through the heat medium passages 103 is discharged to the discharge passage 106 and then sent to the supply passage 105 again by the rotation of the fan 107. Thus, the heat medium circulates in the case 104.

### PRIOR ART DOCUMENT

### Patent Document

Patent Document 1: Japanese Laid-Open Patent Publication No. 2004-288527

### SUMMARY OF THE INVENTION

### Problems that the Invention is to Solve

To circulate the heat medium in the case 104, the battery pack 100 of patent document 1 requires the intake duct 108, which allows the heat medium to be drawn into the heating and cooling means from the discharge passage 106, and the supply duct 109, which sends the heat medium from the heating and cooling means to the supply passage 105. This increases the number of components of the battery pack 100.

It is an object of the present invention to provide a battery pack that does not need a duct to circulate a heat medium in a case and allows for reduction in the number of components.

### Means for Solving the Problems

According to one aspect of the present invention, a battery pack includes a case and a battery module including a plurality of secondary cells arranged in the case. Each secondary cell includes a primary surface and a secondary surface that is opposite to the primary surface. The primary surface includes a terminal, and an inter-cell flow passage is formed between adjacent ones of the secondary cells. A support supports the secondary cells such that the secondary surfaces are separated from a wall surface of the case that faces the secondary surfaces. A circulation device circulates a heat medium in the case. The heat medium flows through the inter-cell flow passage to adjust a temperature of the secondary cells. A primary flow passage is defined in the case between the primary surfaces of the secondary cells and a wall surface of the case that faces the primary surfaces. A secondary flow passage is defined in the case between the secondary surfaces and the wall surface of the case that faces the secondary surfaces. One of the primary flow passage and the secondary flow passage functions as a supply passage that supplies the heat medium to the inter-cell flow passage. The other one of the primary flow passage and the secondary flow passage functions as a discharge passage to which the heat medium is discharged from the inter-cell flow passage.

The second flow passage that functions as one of the supply passage and the discharge passage is a flow passage defined by one surface of each secondary cell, a wall surface of the case, and the support in the case. The circulation device circulates heat medium in the supply passage, the inter-cell flow passage, and the discharge passage. This allows the heat medium to be introduced into the inter-cell flow passage without the need for a duct, which is separate from the case, to circulate the heat medium in the case. Further, the number of components of the battery pack may be reduced.

### BRIEF DESCRIPTION OF THE DRAWINGS

FIG. 1 is a schematic view showing a battery pack according to one embodiment of the present invention.

FIG. 2 is a schematic view showing a case of the battery pack of FIG. 1.

FIG. 3 is an exploded perspective view showing the case of the FIG. 2 from which the top plate is omitted.

FIG. 4 is a perspective view showing a battery module of the battery pack of FIG. 1.

FIG. 5A is a perspective view showing a spacer of the battery module of FIG. 4.

FIG. 5B is a perspective view showing the spacer of FIG. 5A from the opposite side.

FIG. 6 is a cross-sectional view taken along line 6-6 in FIG. 1.

FIG. 7 is a diagram showing the relationship of the spacers and rails.

FIG. 8 is an exploded perspective view showing a temperature adjustment device of the battery pack of FIG. 1.

FIG. 9 is a cross-sectional view taken along line 9-9 in FIG. 6.

FIG. 10 is a cross-sectional view showing prior art.

### MODES FOR CARRYING OUT THE INVENTION

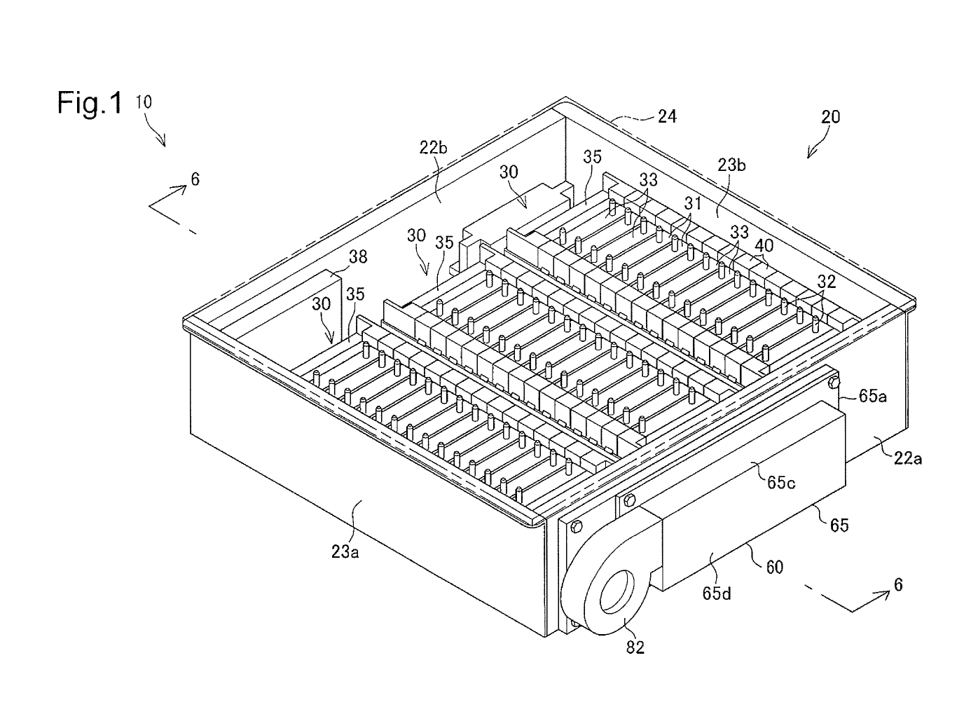

Referring to FIGS. 1 to 9, one embodiment of the present invention will now be described.

As shown in FIG. 1, a battery pack 10 includes a case 20, which has the shape of a rectangular box, a plurality of (three in the present embodiment) battery modules 30, which are accommodated in the case 20, and a temperature adjustment device 60, which is arranged on the case 20.

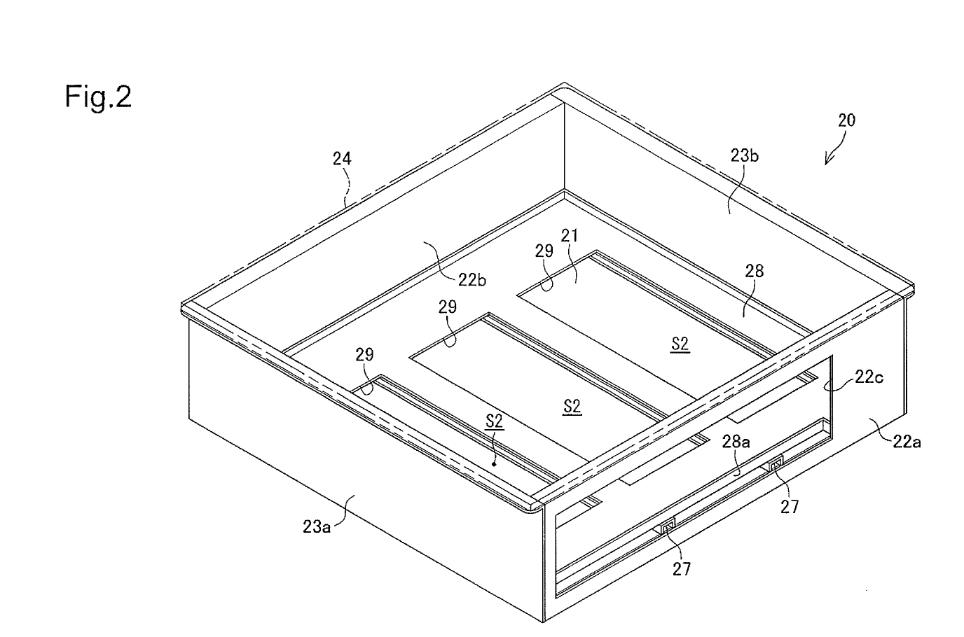

As shown in FIG. 2, the case 20 of the battery pack 10 includes a bottom plate 21, which is a rectangular flat plate, primary side walls 22a and 22b, which extend vertically from the two opposite long sides of the bottom plate 21, secondary side walls 23a and 23b, which extend vertically from the two opposite short sides of the bottom plate 21, and a top plate 24, which is a rectangular flat plate supported by the primary and secondary side walls 22a, 22b, 23a and 23b. The primary side wall 22a located at the first end of the case 20 includes a fitting hole 22c into which the temperature adjustment device 60 is fitted.

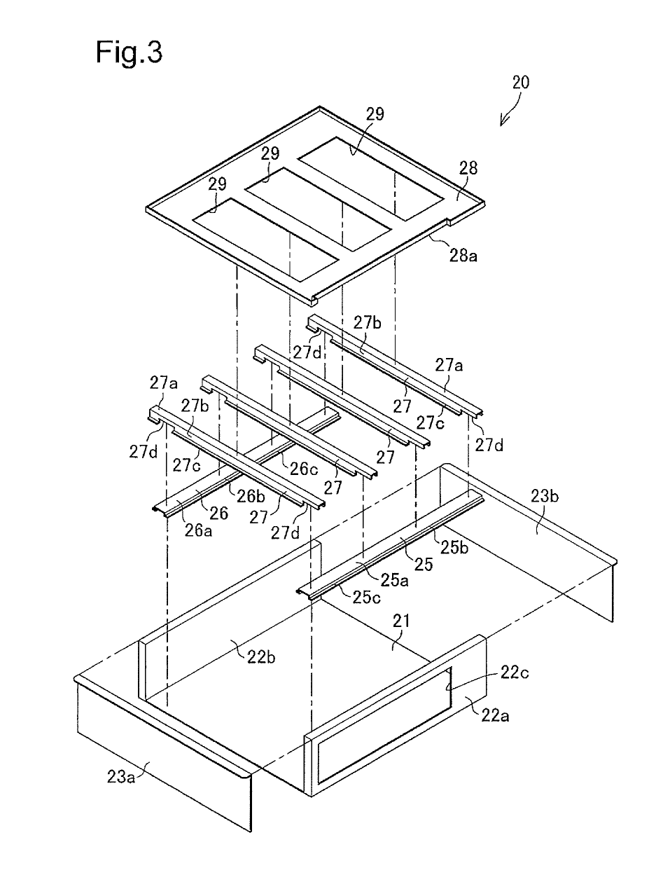

As shown in FIG. 3, a first reinforcement member 25 is fixed to the bottom plate 21 near the primary side wall 22a. The first reinforcement member 25 extends between the secondary side walls 23a and 23b. In addition, a second reinforcement member 26 is fixed to the bottom plate 21 near the primary side wall 22b. The second reinforcement member 26 extends between the secondary side walls 23a and 23b. The first and second reinforcement members 25 and 26 are identical in shape and include bases 25a and 26a, side walls 25b and 26b, and flanges 25c and 26c, respectively. The bases 25a and 26a are rectangular flat plates. The side walls 25b and 26b extend from the two opposite long sides of the corresponding one of bases 25a and 25a. The flanges 25c and 26c are formed at the distal ends of the corresponding side walls 25b and 26b. The flanges 25c and 26c are fixed to the bottom plate 21 such that the first and second reinforcement members 25 and 26 are spaced apart from each other. The length of the long sides of the reinforcement members 25 and 26 is substantially the same as the distance between the secondary side walls 23a and 23b.

Rails 27 are fixed at four locations on the bottom plate 21 of the case 20 in predetermined intervals. The rails 27 function as supports and intersect with the first and second reinforcement members 25 and 26. Each rail 27 extends continuously straight. The rails 27 are identical in shape, and each include a base 27a, which is a rectangular flat plate supporting the battery module 30, side walls 27b, which extend from the long sides of the base 27a, and flanges 27c, which are formed at the distal ends of the side walls 27b. Further, recesses 27d are formed in the opposite longitudinal ends of each side wall 27b. When the flanges 27c are fixed to the bottom plate 21, the rails 27 are arranged on the first and second reinforcement members 25 and 26 such that the reinforcement members 25 and 26 are received in the recesses 27d. The side walls 27b of the rails 27 are taller in height than the side walls 25b and 26b of the reinforcement members 25 and 26.

A middle plate 28 is placed on the bases 27a of the rails 27. The middle plate 28 is a rectangular flat plate that has substantially the same size as the bottom plate 21.

The middle plate 28 includes a plurality of rectangular insertion holes 29. The size of the insertion holes 29 is substantially the same as the size of the rectangular regions surrounded by the first reinforcement member 25, the second reinforcement member 26, and adjacent ones of the rails 27. In particular, the lateral length of the insertion holes 29 is substantially the same as the distance between adjacent ones of the rails 27. The longitudinal length of the insertion holes 29 is substantially the same as the distance between the first and second reinforcement members 25 and 26. Thus, when the middle plate 28 is placed on the bases 27a of the rails 27, the insertion holes 29 of the middle plate 28 are aligned with the regions surrounded by the first reinforcement member 25, the second reinforcement member 26, and adjacent ones of the rails 27. The side of the middle plate 28 that faces the primary side wall 22a includes a recess 28a.

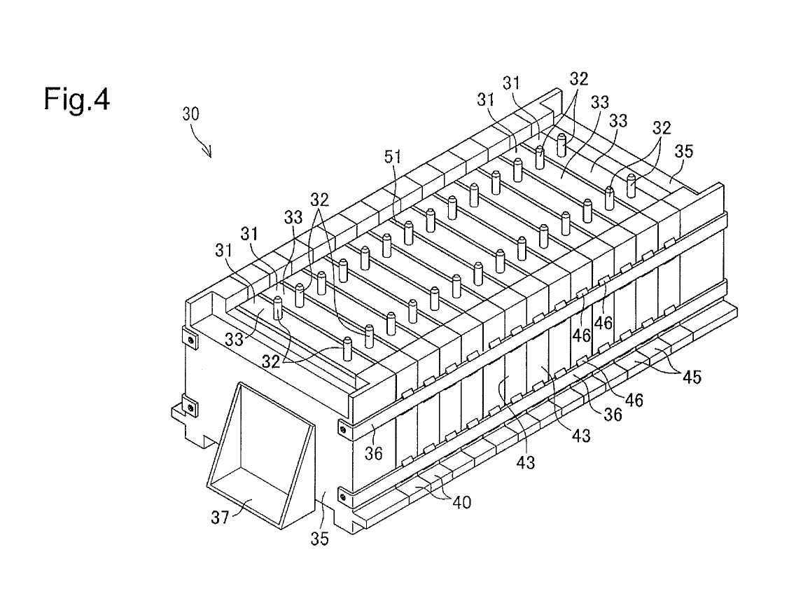

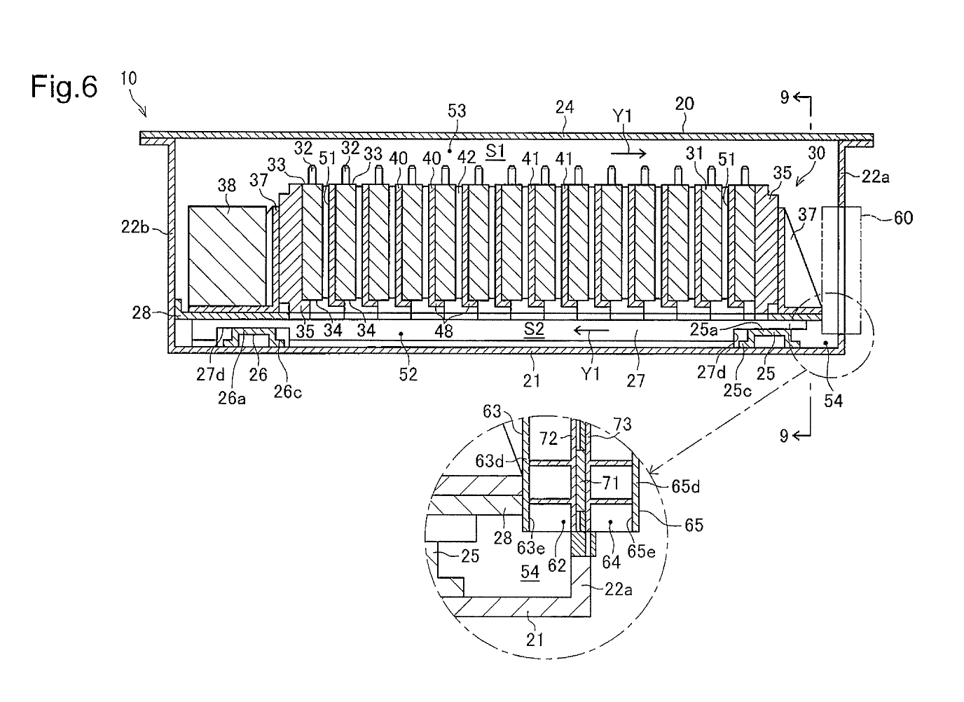

As shown in FIG. 4, each battery module 30 includes a plurality of rectangular cells 31, which are secondary cells. The rectangular cells 31 are arranged in the thickness direction of the rectangular cells 31. Each rectangular cell 31 includes two side surfaces in the thickness direction that are rectangular. Further, each rectangular cell 31 includes a primary surface 33, which is an upper surface, and a secondary surface 34, which is a lower surface that is opposite to the primary surface 33. The primary surface 33 includes terminals 32, and the secondary surface 34 does not include terminals 32 (see FIG. 6). Spacers 40 are arranged between adjacent ones of the rectangular cells 31 to maintain the distance between the rectangular cells 31. An end plate 35 supports each of the rectangular cells 31 that are located at the opposite ends of the battery module 30 in the arrangement direction of the rectangular cells 31. The ends of bands 36, which are made of a metal (e.g., aluminum), are fixed to the end plates 35. The bands 36 are located at positions corresponding to the side surfaces in the lateral direction of the rectangular cells 31 and extend in the arrangement direction of the rectangular cells 31 to integrate the rectangular cells 31 and form a battery module.

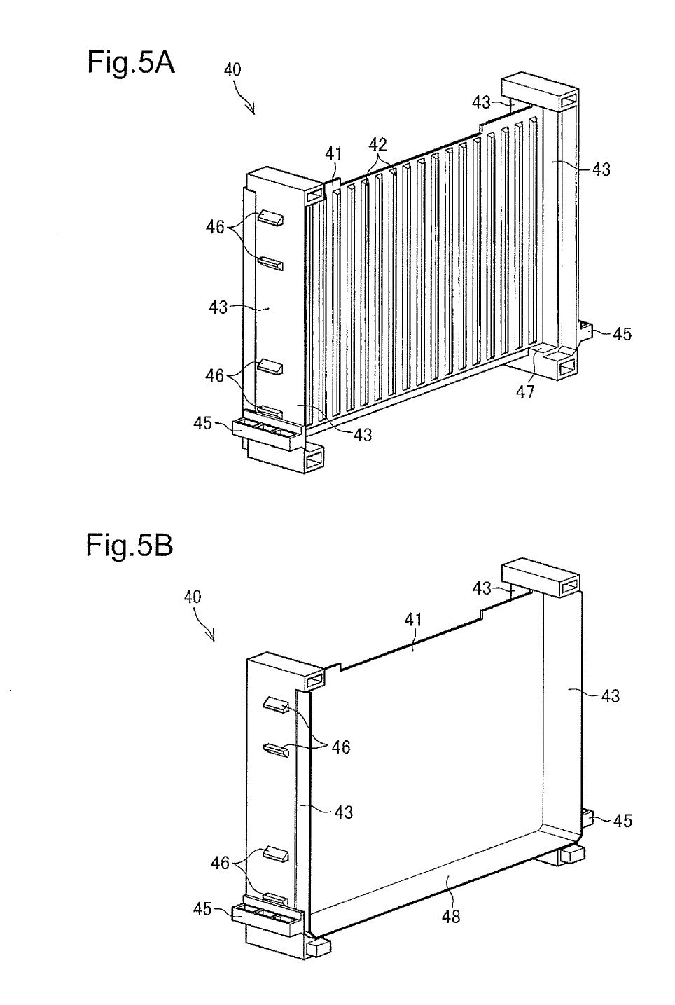

As shown in FIG. 5A, each spacer 40 includes a wall 41 held between the adjacent rectangular cells 31. The wall 41 is rectangular and has substantially the same size as the side surfaces in the thickness direction of the rectangular cells 31. Flow passage formation portions 42 protrude from a first side surface of each wall 41. The flow passage formation portions 42 maintain the distance between the wall 41 and the rectangular cell 31. Each flow passage formation portion 42 extends straight in the height direction of the wall 41 (direction extending from one of the two opposite long sides of the wall 41 to the other). The flow passage formation portions 42 are arranged at predetermined intervals in the lateral direction of the wall 41 (direction extending from one of the two opposite short sides of the wall 41 to the other).

As shown in FIG. 5B, the wall 41 includes a flat second side surface that is opposite to the first side surface. Covering portions 43 are formed at the opposite lateral ends of the spacer 40 (at the two short sides of the wall 41). The covering portions 43 extend perpendicular to the wall 41. The covering portions 43 cover the lateral side surfaces of the rectangular cells 31.

As shown in FIG. 5A, the outer surface of each covering portion 43 includes two pairs of projections 46. The projections 46 are formed on the outer surfaces of the covering portions 43 that correspond to the two lateral side surfaces of each rectangular cell 31, which differ from the primary and secondary surfaces 33 and 34 of the rectangular cell 31. A primary seat 47 is formed in the lower side of each of the two opposing inner surfaces of the covering portions 43 (near one of the long sides of each covering portion 43) to receive a rectangular cell 31.

As shown in FIG. 5B, a secondary seat 48, which receives a rectangular cell 31, is formed on the side surface of each wall 41 that does not include the flow passage formation portions 42. The secondary seat 48 projects from the lower end of the wall 41 (one of the long sides of the wall 41) and extends between the covering portions 43. A protrusion 45 is formed on the lower side of the outer surface of each covering portion 43 (near one of the long sides of each covering portion 43).

As shown in FIG. 4, the spacers 40, which have the structure described above, are arranged between adjacent ones of the rectangular cells 31. The two lateral side surfaces of each rectangular cell 31 are covered by the covering portions 43 of the adjacent spacers 40. The secondary surfaces 34 of the rectangular cells 31 are placed on the primary seats 47 and the secondary seats 48 of the adjacent spacers 40. In addition, the projections 46 hold the bands 36, which are fixed to the end plates 35. That is, the bands 36, which are arranged at the sides of each rectangular cells 31 corresponding to the two lateral side surfaces of the rectangular cell 31, which are the surfaces of the rectangular cells 31 that differ from the primary surface 33 and the secondary surface 34, integrate the rectangular cells 31 to form the battery module 30. Accordingly, the end plates 35, the spacers 40, and the bands 36 integrate the rectangular cells 31 to form the battery module 30. The battery module 30 is coupled to the case 20 by brackets 37, which are coupled to the end plates 35.

As shown in FIG. 6, when the spacers 40 are arranged between adjacent ones of the rectangular cells 31, the flow passage formation portions 42 prevent contact between the rectangular cells 31 and primary surfaces of the spacers 40. This forms inter-cell flow passages 51 between the primary surfaces of the spacers 40 and the rectangular cells 31. Further, a junction box 38 is set on one of the two brackets 37 that couple the battery module 30 to the case 20.

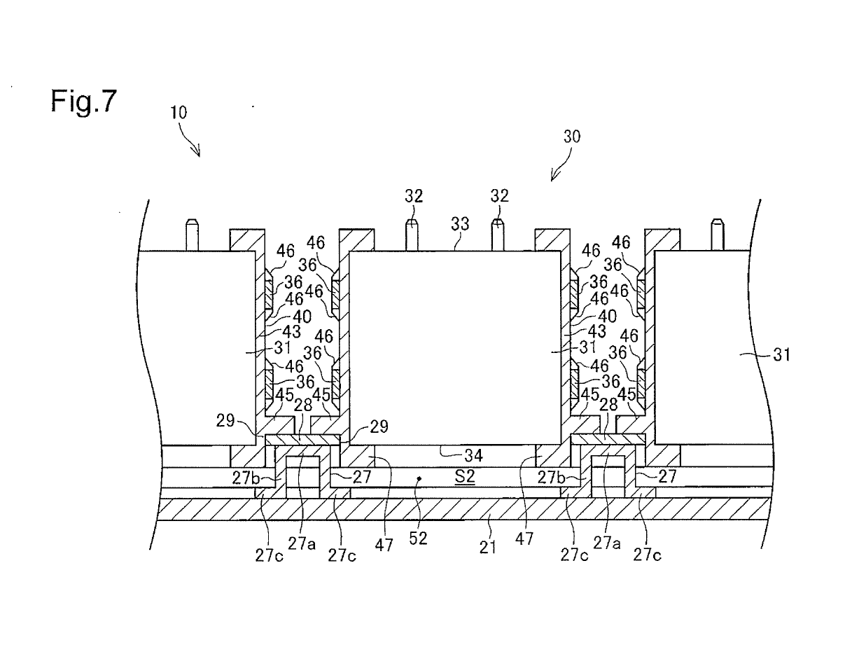

As shown in FIG. 7, when the battery modules 30 are coupled to the case 20, the bases 27a of the rails 27 support the protrusions 45 of the spacers 40 with the middle plate 28 arranged in between.

As shown in FIG. 6, a primary flow passage S1 is defined between the primary surfaces 33 of the rectangular cells 31 and the inner surface of the top plate 24 (wall surface of the case 20), which faces the primary surfaces 33 in each battery module 30. In addition, a secondary flow passage S2 is defined and surrounded by the secondary surfaces 34 of the rectangular cells 31, the inner surface of the bottom plate 21 (wall surface of the case 20) that faces the secondary surfaces 34, and the rails 27 in each battery module 30. As shown in FIG. 2, the secondary flow passage S2 is one of three flow passages defined by the rails 27. As shown in FIG. 6, the inter-cell flow passages 51, which are formed between adjacent ones of the rectangular cells 31, communicate the primary flow passage S1 and the secondary flow passages S2.

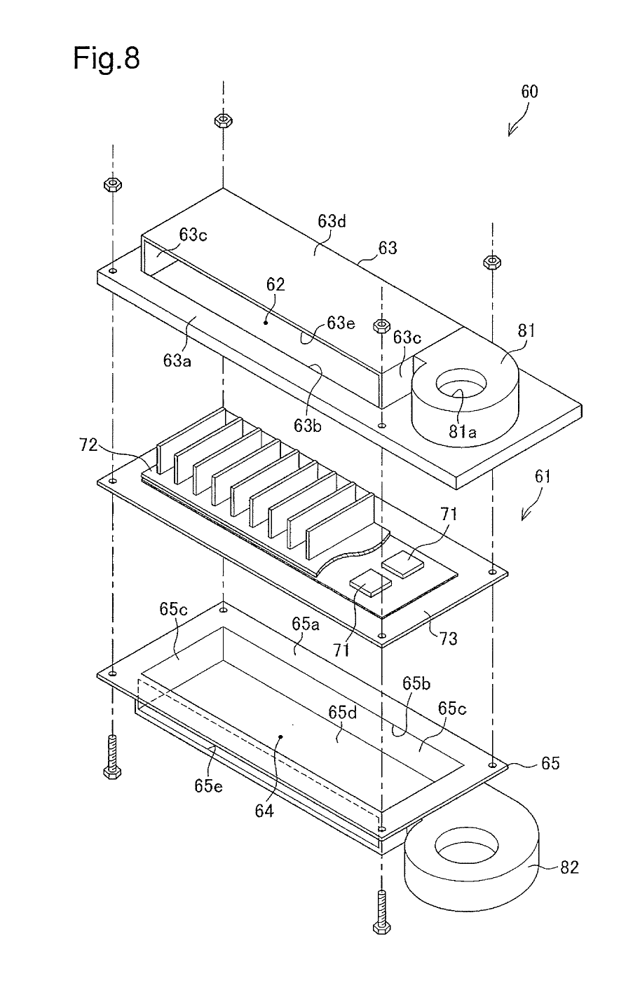

As shown in FIG. 8, the temperature adjustment device 60, which is fitted into the fitting hole 22c, includes a thermoelectric conversion unit 61, a first flow passage member 63, and a second flow passage member 65. The first flow passage member 63 is combined with the thermoelectric conversion unit 61 and forms a first flow passage 62, which adjusts the temperature of a heat medium. The second flow passage member 65 is combined with the thermoelectric conversion unit 61 and forms a second flow passage 64, which adjusts the temperature of the heat medium.

The thermoelectric conversion unit 61 includes a plurality of thermoelectric conversion elements 71, a first heat sink 72, and a second heat sink 73. The thermoelectric conversion elements 71 are located between the first and second heat sinks 72 and 73. In accordance with the polarity of the electric current flowing through the thermoelectric conversion elements 71, one of the first and second heat sinks 72 and 73 is heated, and the other one is cooled.

The first flow passage member 63 includes a base 63a, which has the shape of a rectangular frame. The base 63a includes a rectangular opening 63b. Side walls 63c extend from a first short side, a second short side, and a first long side of the opening 63b. A side wall 63d is arranged on the distal ends of the side walls 63c. The opening 63b in the base 63a and the side walls 63c and 63d define the first flow passage 62. A flow outlet 63e is formed along a second long side of the opening 63b. The heat medium flows out of the first flow passage 62 through the flow outlet 63e. A first blower 81 is arranged on the base 63a of the first flow passage member 63. The first blower 81 supplies a gaseous heat medium (e.g., air or carbon dioxide) to the first flow passage 62. The first blower 81 includes an intake port 81a through which the heat medium is drawn into the first blower 81 from the outer side of the thermoelectric conversion unit 61. The heat medium drawn into the first blower 81 through the intake port 81a is then supplied to the first flow passage 62. The intake port 81a is in communication with the downstream end of the primary flow passage S1. The heat medium is drawn into the intake port 81a from the downstream end of the primary flow passage S1.

The second flow passage member 65 includes a base 65a, which has the shape of a rectangular frame. The base 65a includes a rectangular opening 65b. Side walls 65c extend from a first short side, a second short side, and a first long side of the opening 65b. A side wall 65d is arranged on the distal ends of the side walls 65c. The opening 65b in the base 65a and the side walls 65c and 65d define a second flow passage 64. A flow outlet 65e of the second flow passage 64 is formed along a second long side of the opening 65b. The heat medium that flows into the second flow passage 64 is discharged from the flow outlet 65e. A second blower 82 is arranged on the second flow passage member 65. The second blower 82 supplies a gaseous heat medium to the second flow passage 64. The second blower 82 includes an intake port (not shown) through which the heat medium is drawn into the second blower 82 from the outer side of the thermoelectric conversion unit 61. The heat medium drawn into the second blower 82 through the intake port is supplied to the second flow passage 64.

As shown in FIG. 6, when the temperature adjustment device 60 is fitted into the fitting hole 22c of the case 20, the first flow passage member 63 is located inside the case 20 and the second flow passage member 65 is located outside the case 20. The boundary between the temperature adjustment device 60 and the fitting hole 22c is sealed by a sealing member (not shown) such as a rubber gasket or a liquid gasket. This prevents the heat medium from flowing out of the case 20. Thus, when fitted into the fitting hole 22c, the temperature adjustment device 60 forms a portion of the primary side wall 22a. The first flow passage member 63 is fitted in the recess 28a of the middle plate 28 to disconnect the primary flow passage S1 and the secondary flow passages S2. The flow outlet 63e of the first flow passage member 63 of the temperature adjustment device 60 is located between the middle plate 28 and the bottom plate 21. In addition, the first blower 81 of the temperature adjustment device 60 is located between the middle plate 28 and the top plate 24.

In the battery pack 10 having the structure described above, as indicated by the arrow Y1, the heat medium in the primary flow passage S1 is drawn into the first flow passage 62 of the temperature adjustment device 60 by the first blower 81. The thermoelectric conversion elements 71 adjust the temperature of the heat medium in the first flow passage 62. Then, the heat medium is supplied to the secondary flow passages S2 by the first blower 81. Thus, in the battery pack 10 of the present embodiment, the secondary flow passages S2 function as supply passages 52 that supply the heat medium to the inter-cell flow passages 51. The heat medium supplied to the secondary flow passages S2 flows through the inter-cell flow passages 51 and is discharged into the primary flow passage S1. Thus, the primary flow passage S1 functions as a discharge passage 53 into which the heat medium is discharged after flowing through the inter-cell flow passages 51. The first blower 81, which supplies the heat medium to the supply passages 52 from the discharge passage 53, functions as a circulation device.

As shown in the enlarged view of the FIG. 6, the first reinforcement member 25 is separated from the primary side wall 22a. This forms a distribution chamber 54 between the flow outlet 63e of the first flow passage member 63 and the supply passages 52. The distribution chamber 54 is in communication with the supply passages 52 and distributes the heat medium supplied by the first blower 81 to the supply passages 52. The distribution chamber 54 is a region surrounded by the middle plate 28, the temperature adjustment device 60, the bottom plate 21, and the first reinforcement member 25. The distribution chamber 54 is located at the first end of the case 20.

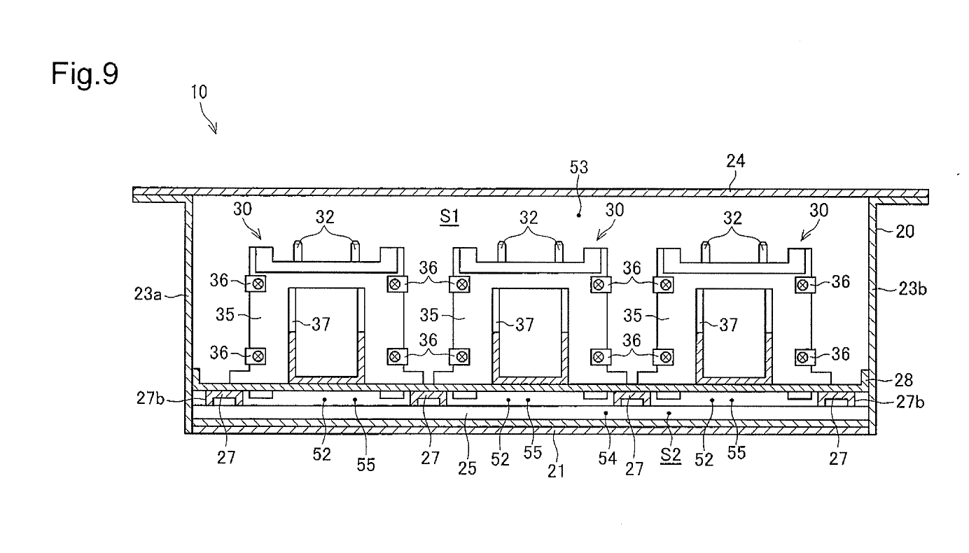

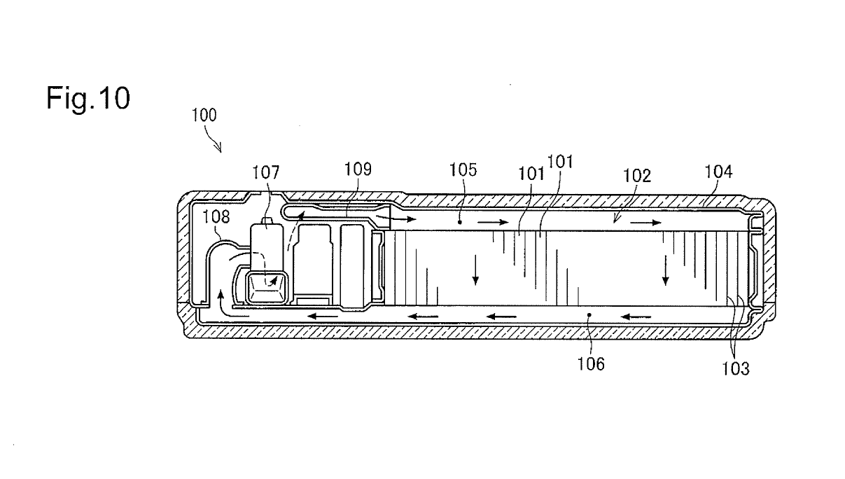

As shown in FIG. 9, the length of the distribution chamber 54 in the arrangement direction of the rails 27 is substantially the same as the distance between the opposing secondary side walls 23a and 23b. The distribution chamber 54 is connected to the supply passages 52 by clearances 55 formed between the middle plate 28 and the first reinforcement member 25. That is, the distribution chamber 54 is in communication with each of the three secondary flow passages S2, which are defined by the rails 27. The difference between the height of the side walls 27b of the rails 27 and the height of the side walls 25b of the first reinforcement member 25 forms the clearances 55. To be more specific, the height of the side walls 27b of the rails 27 is greater than the height of the side walls 25b of the first reinforcement member 25. Thus, the middle plate 28, which is placed on the rails 27, is separated from the first reinforcement member 25. This forms the clearances 55. The cross-sectional area of the clearance 55 perpendicular to the flow direction of the heat medium is smaller than the cross-sectional area of the supply passage 52.

The operation of the battery pack 10 having the structure described above will now be described.

When the battery pack 10 in used in the winter season or in a cold climate, for example, the rectangular cells 31 are heated if the ambient temperature is low such that the discharging of the rectangular cells 31 would be hindered. Specifically, the thermoelectric conversion elements 71 are energized to heat the first heat sink 72. This supplies the heated heat medium to the distribution chamber 54 from the flow outlet 63e.

In contrast, the rectangular cells 31 are cooled when the rectangular cells 31, during use, are heated to a temperature that may hinder discharging. Specifically, the thermoelectric conversion elements 71 are energized to cool the first heat sink 72. This supplies the cooled heat medium to the distribution chamber 54 from the flow outlet 63e.

The heat medium supplied to the distribution chamber 54 from the flow outlet 63e is distributed to the supply passages 52. Here, the heat medium flows to the supply passages 52 through the clearances 55 formed between the first reinforcement member 25 and the middle plate 28. The clearance 55 has a smaller cross-sectional area than the supply passages 52. Thus, the clearances 55 restrict the flow of heat medium from the distribution chamber 54 to the supply passages 52. This reduces situations in which the supply passage 52 that is closer to the flow outlet 63e is supplied with more heat medium than the supply passage 52 that is farther from the flow outlet 63e. That is, the clearances 55 reduce differences between the supply passages 52 in the amount of the supplied heat medium.

The heat medium supplied to the supply passages 52 then flows to the inter-cell flow passages 51. The heat medium exchanges heat with the rectangular cells 31 while flowing through the inter-cell flow passages 51. After exchanging heat with the rectangular cells 31, the heat medium is discharged to the discharge passage 53. The heat medium discharged to the discharge passage 53 is drawn into the first blower 81. The heat medium drawn in the first blower 81 is heated or cooled by the first heat sink 72 and then supplied to the distribution chamber 54 again. Accordingly, the heat medium circulates in the case 20 to adjust the temperature of the rectangular cells 31.

The advantages of the present embodiment will now be described.

(1) The secondary flow passages S2 function as the supply passages 52. The secondary flow passages S2 are defined and surrounded by the secondary surfaces 34 of the rectangular cells 31 of the battery module 30, the inner surface (wall surface) of the bottom plate 21 of the case 20, and the rails 27. The primary flow passage S1 functions as the discharge passage 53. The primary flow passage S1 is formed between the primary surfaces 33 of the rectangular cells 31 and the inner surface (wall surface) of the top plate 24 of the case 20. Thus, in the battery pack 10, the heat medium can be circulated through the inter-cell flow passages 51 between the rectangular cells 31 without the need for a duct that circulates the heat medium in the case 20.

(2) The secondary flow passages S2 function as the supply passages 52. The secondary flow passages S2 are formed between the inner surface of the case 20 and the secondary surfaces 34 of the rectangular cells 31 that do not include the terminals 32. The secondary surfaces 34 are flat surfaces. Thus, the terminals 32 of the rectangular cells 31 do not project in the supply passages 52 and therefore do not block the flow of heat medium in the supply passages 52. In FIG. 6, the secondary seats 48 are illustrated to be thicker than they actually are for illustration purpose. In fact, the secondary seats 48 are thin and form a substantially flat surface with the secondary surfaces 34 of the rectangular cells 31.

(3) The distribution chamber 54 is formed between the temperature adjustment device 60 and the supply passages 52. The heat medium that is subjected to temperature adjustment in the temperature adjustment device 60 is then supplied to the supply passages 52 through the distribution chamber 54. This reduces the variations in the amount of flowing heat medium between the supply passages 52. Thus, the variations in the efficiency of temperature adjustment for the battery modules 30 are reduced, and the variations in the temperatures of the rectangular cells 31 in each battery module 30 are reduced. Further, the distribution chamber 54 is formed by the first reinforcement member 25 and the middle plate 28, and the heat medium is distributed to the secondary flow passages S2 defined by the rails 27. This eliminates the need for a separate duct.

(4) The bands 36, which integrate the battery module 30, are arranged at positions corresponding to the lateral side surfaces of the rectangular cells 31 and do not cover the primary surfaces 33 and the secondary surfaces 34. In addition, the inter-cell flow passages 51, through which the heat medium flows, extend from the primary surfaces 33 to the secondary surfaces 34. Thus, the bands 36 do not block the heat medium flowing through the inter-cell flow passages 51.

(5) The rails 27, which extend continuously straight, function as supports that support the battery module 30. This increases the area that receives the load of the battery module 30 compared to a structure in which supports are formed discontinuously. Thus, the pressure applied to the rails 27 and the bottom plate 21 of the case 20 is appropriately dispersed. This limits deformation of the rails 27 and the bottom plate 21 that would be caused by the load of the battery module 30. That is, the rails 27 function as reinforcement ribs.

(6) The rails 27 that support the battery module 30 are used in the battery pack 10, which is of a typical type. That is, the rails 27 are not dedicated to the battery pack 10 of the present embodiment and are typically included as general components of the battery pack 10. The use of the rails 27 when forming the supply passages 52 eliminates the need for additional components to form the supply passages 52. Thus, the supply passages 52 can be formed without increasing the number of components. In particular, the supply passages 52 can be formed without increasing the number of components even when a plurality of the battery modules 30 is arranged.

(7) Since the rails 27 are components that are generally included in a battery pack 10, the supply passages 52 can be formed without increasing the size of the battery pack 10. Thus, the elimination of need for a duct in the battery pack 10 reduces the size of the battery pack 10.

(8) The junction box 38 is arranged on the bracket 37. If a duct were to be arranged at one end of the battery module 30 in the thickness direction of the rectangular cell 31, the duct would be placed on the bracket 37. Thus, the junction box 38 would be placed at the outer side of the duct. In the present embodiment, the absence of a duct on the bracket 37 allows the junction box 38 to be placed on the bracket 37. Thus, the junction box 38 does not have to be placed at the outer side of a duct. This reduces the size of the battery pack 10.

(9) When the spacers 40 are arranged between adjacent ones of the rectangular cells 31, the flow passage formation portions 42 of the spacers 40 form the inter-cell flow passages 51 extending in the height direction of the rectangular cells 31. Thus, the inter-cell flow passages 51 extending in the height direction of the rectangular cells 31 are formed between adjacent ones of the rectangular cells 31.

(10) The spacers 40 include the projections 46 that hold the bands 36. The projections 46 prevent displacement of the bands 36. This allows the bands 36 to keep the battery module 30 integrated.

(11) The spacers 40 include the protrusions 45 that are supported by the upper surfaces of the rails 27 when the battery module 30 is accommodated in the case 20. The middle plate 28 is arranged between the protrusions 45 and the upper surfaces of the rails 27. Thus, the battery module 30 is separated from the bottom plate 21 and arranged on the supply passage 52.

It should be apparent to those skilled in the art that the present invention may be embodied in many other specific forms without departing from the spirit or scope of the invention. Particularly, it should be understood that the present invention may be embodied in the following forms.

The rectangular cells 31 may be arranged such that the primary surfaces 33 including the terminals 32 face the supply passages.

The bands 36 may be omitted.

The bands 36 may be arranged on the side surfaces in the height direction of the rectangular cells 31. In this case, it is preferred that the bands 36 be insulated from the terminals 32 of the rectangular cells 31 and the bus bars connecting the terminals 32.

Components other than the rails 27 may function as supports. For example, a plurality of supports may be arranged at predetermined intervals between the first reinforcement member 25 and the second reinforcement member 26. Alternatively, the bottom plate 21 may include a plurality of projections that extend in the case 20 and function as supports. Further, supports may be used that project from the primary side walls 22a and 22b and the secondary side walls 23a and 23b in the case 20.

In the present embodiment, the distribution chamber 54 is arranged between the primary side wall 22a and the first reinforcement member 25. However, a chamber box, which is in communication with the supply passages 52, may be arranged on the first reinforcement member 25, for example. The heat medium may be supplied to the chamber box from the flow outlet 63e of the first flow passage member 63. In this case, the chamber box functions as a distribution chamber.

The primary flow passage S1 may function as the supply passage 52, and the secondary flow passages S2 may function as the discharge passages 53. In other words, the flow direction of the heat medium moved by the first blower 81 may be changed so that the heat medium supplied to the inter-cell flow passages 51 from the primary flow passage S1 is discharged to the secondary flow passages S2 and then returned to the first blower 81 from the secondary flow passages S2.

The flow passage formation portions 42 may be formed on the both sides of each wall 41. In this case, when the spacers 40 are arranged between adjacent ones of the rectangular cells 31, the inter-cell flow passages 51 are formed between each side surface in the thickness direction of the rectangular cells 31 and the adjacent spacer 40.

The rail 27 may include a communication hole that communicates the adjacent ones of the supply passages 52. In this case, when the flow rates of heat medium supplied to the supply passages 52 are not uniform, heat medium moves from a supply passage 52 that is receiving more heat medium to a supply passage 52 that is receiving less heat medium. This reduces the variations in the flow rates of heat medium among the supply passages 52.

The case 20 may have the shape of a polygon, such as a triangle or a pentagon, or may be circular.

The first and second reinforcement members 25 and 26 may be omitted.

The middle plate 28 may be omitted, and the battery module 30 may be placed directly on the bases 27a of the rails 27.

The number of the battery modules 30 accommodated in the case 20 may be changed. In this case, the number of the supply passages 52 needs to be changed in accordance with the number of the battery modules 30. The number of the battery modules 30 may be singular or plural.

The spacer 40 may be omitted if adjacent ones of the rectangular cells 31 can be separated from each other.

The secondary cells may be cylindrical cells or laminated cells. The shape of the spacers 40 may be changed in accordance with the shape of the secondary cells.

In the embodiment described above, the three supply passages 52 are provided in correspondence with the battery modules 30. However, a single supply passage 52 may supply the heat medium to the inter-cell flow passages 51 of each battery module 30. That is, among the rails 27 fixed at the four locations on the bottom plate 21 in the embodiment described above, just the two rails 27 that are adjacent to the secondary side walls 23a and 23b may be arranged on the bottom plate 21.

The bands 36 may be made of other materials such as resin.

In the above embodiment, the temperature adjustment device 60, which includes the thermoelectric conversion elements 71, is used as the temperature adjustment device. However, other heat exchange methods may be used. The air outside the case 20 may be drawn into and circulated in the case 20.

1-8. (canceled)

9. A battery pack comprising:
a case;
a battery module including a plurality of secondary cells arranged in the case, wherein each secondary cell includes a primary surface and a secondary surface that is opposite to the primary surface, the primary surface includes a terminal, and an inter-cell flow passage is formed between adjacent ones of the secondary cells;
a support that supports the secondary cells such that the secondary surfaces are separated from a wall surface of the case that faces the secondary surfaces; and
a circulation device that circulates a heat medium in the case, wherein the heat medium flows through the inter-cell flow passage to adjust a temperature of the secondary cells, wherein
a primary flow passage is defined in the case between the primary surfaces of the secondary cells and a wall surface of the case that faces the primary surfaces,
a secondary flow passage is defined in the case between the secondary surfaces and the wall surface of the case that faces the secondary surfaces,
one of the primary flow passage and the secondary flow passage functions as a supply passage that supplies the heat medium to the inter-cell flow passage,
the other one of the primary flow passage and the secondary flow passage functions as a discharge passage to which the heat medium is discharged from the inter-cell flow passage,
the supply passage is one of a plurality of supply passages,
a distribution chamber is formed in the case, and
the distribution chamber is in communication with the supply passages and distributes the heat medium to the supply passages.

10. The battery pack according to claim 9, wherein the secondary flow passage functions as the supply passage, and the first flow passage functions as the discharge passage.

11. The battery pack according to claim 9, wherein
the circulation device is arranged at a first end of the case,
the distribution chamber is located at the first end of the case, and
the circulation device includes an intake port, which is in communication with a downstream end of the discharge passage, and a flow outlet, which is in communication with the distribution chamber.

12. The battery pack according to claim 9, wherein the support includes at least a pair of rails extending in an arrangement direction of the secondary cells.

13. The battery pack according to claim 9, wherein
the support includes at least a pair of rails extending in an arrangement direction of the secondary cells, and
the distribution chamber is formed by a reinforcement member, which is perpendicular to the rails and is shorter in height than the rails, and a plate arranged on the rails.

14. The battery pack according to claim 9, wherein the secondary cells are integrated by a band to form the battery module, and
the band is arranged at a side corresponding to surfaces that differ from the primary surfaces and the secondary surfaces.

15. The battery pack according to claim 9, further comprising a temperature adjustment device that adjusts a temperature of the heat medium.
